(19) United States
(12) Patent Application Publication
(10) Pub. No.: US 2008/0283347 A1
(43) Pub. Date: Nov. 20, 2008

(54) Electromechanical Friction Brake

(76) Inventors: Chi-Thuan Cao, Korntal-Muenchingen (DE); Dietmar Baumann, Hemmingen (DE); Dirk Hofmann, Stuttgart (DE); Herbert Vollert, Vaihingen/Enz (DE); Willi Nagel, Remseck/Hochdorf (DE); Andreas Henke, Diemelstadt (DE); Bertram Foitzik, Ilsfeld (DE); Bernd Goetzelmann, Sindelfingen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/096,471

(22) PCT Filed: Dec. 22, 2006
(86) PCT No.: PCT/EP2006/070202

§ 371 Date: Jun. 6, 2008

(30) Foreign Application Priority Data
Jan. 9, 2006 (DE) 10 2006 001 133.3

(51) Int. Cl. B60L 7/26

(52) U.S. Cl. 188/161

(57) ABSTRACT

The invention relates to a self-energizing electromechanical friction brake includes a self-energizing device provided with, for example, a wedge mechanism. According to the invention, the friction brake is equipped with a linear drive, for example an electromagnet, for brake actuation. The self-energizing device converts a friction force exerted by a rotating brake body on a friction brake lining during braking actuated by the linear drive of an actuation device into a second contact pressure that presses the friction brake lining against the brake body in addition to the first contact pressure exerted by the actuation device. The self-energizing device provides a non-proportional characteristic magnetic force curve of the electromagnet of the linear drive.

### PRIOR ART

The invention relates to an electromechanical friction brake having the characteristics of the preamble to claim 1, which is intended as a vehicle brake for motor vehicles.

Electromechanical friction brakes are know. For example, see International Patent Disclosure WO 02/40 887 A1. The known function brake is embodied as a disk brake. It has a friction brake lining, which for braking can be pressed by an electromechanical actuation device against a brake disk. The brake disk forms a brake body; in the case of a drum brake, the brake body is the brake drum. The invention can also be employed with other forms of brakes. The actuation device in the known friction brake has an electric motor and a helical gear in the form of a ball screw for converting the rotary motion of the electric motor into a translational motion for pressing the friction brake lining against the brake body. A speed-reducing gear can be disposed between the electric motor and the screw.

The known friction brake has a self-energizing device, which converts a frictional force, exerted by the rotating brake disk on the friction brake lining pressed against it in braking, into a contact pressure that, in addition to a contact pressure exerted by the actuation device, presses the friction brake lining against the brake disk. To distinguish it from the contact pressure that the actuation device exerts, the contact pressure exerted by the self-energizing device will hereinafter be called the self-energizing force. The known friction brake has a wedge mechanism with wedge elements on a back side of the friction brake lining, facing away from the brake disk, which extend at a wedge angle obliquely to the brake disk. The wedge elements are braced on abutment faces in the brake caliper, which likewise extend obliquely to the brake disk at the wedge angle. The frictional force exerted by the rotating brake disk in the circumferential direction on the friction brake lining pressed against it in braking, because of the principle of the wedge, produces a force that has a component transverse to the brake disk. This force component is the contact pressure, hereinafter called the self-energizing force, that is exerted by the self-energizing device.

The known friction brake has wedge elements and abutment faces that slope upward in opposite directions, so as to attain self-energizing in both directions of rotation of the brake disk. The wedge angle for travel forward and in reverse may differ, in order to attain self-energizing actions of different magnitudes. Still other self-energizing devices are also possible, for instance with support levers stressed by tension or compression, which brace the friction brake at a support angle oblique to a normal to the brake disk. This is a mechanical equivalent of the wedge mechanism described; the support angle of the lever mechanism is equivalent to the wedge angle of the wedge mechanism. Still other self-energizing devices, for instance hydraulic ones, are known and possible.

### EXPLANATION AND ADVANTAGES OF THE INVENTION

The actuation device of the friction brake of the invention having the characteristics of claim 1 has a linear drive for pressing the friction brake lining against the brake body. The linear drive generates a translational motion, which is in particular but not necessarily straight, for pressing the friction brake lining against the brake body. The linear drive is preferably electrical; it may for instance have one or more piezoelectric elements. Preferably, it has an electromagnet. The linear drive has the advantage that it generates a translational motion with which the friction brake lining can be moved directly and pressed against the brake body. The conversion of a rotational motion into a translational motion is then dispensed with. The linear drive may be embodied as a direct drive, that is, without the interposition of a speed-reducing or speed-increasing gear. With the omission of gears, the production cost, structural size, and mass can be reduced as well. Wear and maintenance of the gears are eliminated; the maintenance is reduced. The likelihood of failure of the linear drive is also reduced, compared to an electric motor. A further advantage is a design-dictated limited stroke of a linear drive, which as a function of its construction makes it possible to embody the vehicle brake without end stops for the friction brake lining.

The dependent claims have advantageous features and refinements of the invention defined by claim 1 as their subjects.

Claim 3 provides a non-proportional characteristic magnetic force curve of the electromagnet of the linear drive; claim 4 provides a progressive characteristic magnetic force curve. The characteristic magnetic force curve indicates the relationship between the force of the electromagnet and the travel (for instance with constant electrical voltage). The dependence of the magnetic force on the travel can be varied, among other factors by the geometrical shapes of an armature and of a pole piece of the electromagnet. By means of the non-proportional characteristic magnetic force curve, it is possible to adapt to the characteristic of the friction brake. By means of a progressive characteristic magnetic force curve, an actuation force that increases disproportionately when the braking force is great is attained. The goal is to optimize the electromagnet with regard to the lifting work, for instance (actuation energy of the friction brake) and/or the structural size of the electromagnet.

The desired course of the characteristic magnetic force curve in the operating range of the electromagnet, that is, in the stroke range employed upon actuation of the friction brake, suffices. Any deviation in the course of the characteristic magnetic force curve outside the operating range is of no significance.

Claim 5 provides a self-locking embodiment of the self-energizing device. The wedge angle is selected to be acute enough that self-locking occurs. To avoid locking of the brake body, the friction brake lining must be restrained by the actuation device when the friction brake has been actuated to prevent a motion in the tightening direction of the friction brake. The wedge angle can be selected to be so acute that self-locking occurs at the least coefficient of friction between the friction brake lining and the brake body. At the least coefficient of friction, the friction brake of the invention can theoretically be actuated without energy; at a medium coefficient of friction, which is the most frequent case in actuality, the actuation of the friction brake is effected with only slight actuation energy. For comparison, claim 6 provides a restoring spring element which urges the friction brake lining in the release direction of the friction brake. It is designed in particular such that its restoring force, at the maximum coefficient of friction between the friction brake lining and the brake body, prevents the friction brake lining from moving in the tightening direction of the friction brake. Optionally, a margin of safety can be provided; that is, the restoring force can be selected to be greater, so as to reliably prevent locking of the brake body despite the self-locking self-energizing device. The friction brake lining is urged in the tightening direction of the friction brake by the frictional force exerted by the rotating brake body on the function brake lining pressed against the brake body in braking. The restoring spring element has the advantage that its restoring force is oriented counter to the frictional force that the rotating brake body exerts on the friction brake lining that is pressed against it in braking, so that the actuation force to be exerted by the actuation device is reduced. If at the maximum coefficient of friction the restoring spring element restrains the friction brake lining from moving in the tightening direction, this has the additional advantage that self-locking of the friction brake is avoided even if the actuation device fails; that is, unwanted locking of the brake body is prevented.

### DRAWINGS

The invention is described below in further detail in terms of exemplary embodiments shown in the drawings. Shown are:

FIG. 1, a friction brake of the invention;

FIG. 2, an electromagnet of an actuation device of the friction brake of FIG. 1;

FIG. 3, a characteristic magnetic force curve of the electromagnet of FIG. 2;

FIG. 4, a restoring spring element of the friction brake of FIG. 1;

FIG. 5 parts of a modified friction brake according to the invention; and

FIG. 6, a detailed view of a further modification of the friction brake of FIG. 1 according to the invention.

The drawings are understood to be schematic, simplified illustrations for the sake of comprehension of the invention.

### DESCRIPTION OF THE EXEMPLARY EMBODIMENTS

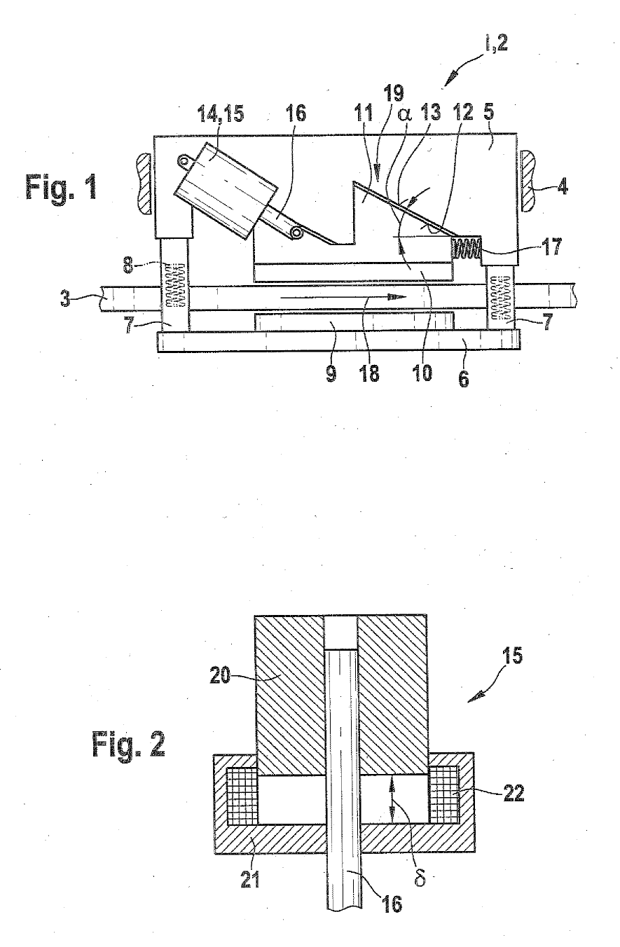

The electromechanical friction brake of the invention shown in FIG. 1 is embodied as a disk brake 1. It has a brake caliper 2, which, as a so-called floating caliper with a symbolically shown caliper guide 4, is guided displaceably transversely to a brake disk 3. The brake disk 3 forms a brake body that is to be braked by the disk brake 1. The brake caliper 2 is embodied as a floating brake; it has a base body 5 on one side of the brake disk 3 and a plate 6 on the opposite side of the brake disk 3. The base body 5 and the plate 6 are rigidly joined to one another by two tie rods 7. Elastic deformability and widenability of the brake caliper 2 is indicated by the spring symbols 8 in the tie rods 7.

A friction brake lining 9 is disposed immovably on the plate 6 of the brake caliper 2 and will hereinafter be called the fixed friction brake lining 9. On the other side of the brake disk 3, a friction brake lining 10 that is movable in the circumferential or chord direction of the brake disk 3 is disposed in the brake caliper 2. The brake disk 3 forms a brake body that is to be braked by the disk brake 1. The movable friction brake lining 10 has a wedge body 11 with a plurality of wedge faces 12, parallel to one another, on its back side remote from the brake disk 3. The wedge faces 12 extend at a wedge angle α to the circumferential direction of the brake disk 3. With the wedge faces 12, the movable friction brake lining 10 is supported displaceably in the circumferential direction of the brake disk 3 on complementary abutment faces 13 of the base part 5 of the brake caliper 2. The abutment faces 13 likewise extend at the wedge angle α to the brake disk 3. In precise terms, the friction brake lining 10 is movable along a helical path whose slope corresponds to the wedge angle α and whose imaginary axis coincides with an imaginary axis of rotation of the brake disk 3. Other path courses (not shown) are possible, such as in the chord direction and at the same time at the wedge angle α to the brake disk 3. What is essential to attain self-energizing that will be explained hereinafter is that with the disk brake 1 actuated, a frictional force exerted by the rotating brake disk 3 on the friction brake lining 10 pressed against it urges the friction brake lining 10 in the direction of an increasingly narrower wedge gap between the brake disk 3 and the abutment faces 13.

The disk brake 1 has a linear drive 14 as its actuation device. In the exemplary embodiment, the linear drive 14 is a rectilinear drive, but this is not compulsory. The linear drive 14 has an electromagnet 15, shown enlarged in axial section in FIG. 2; it is braced on the base body 5 of the brake caliper 2, and with a tappet 16, it engages the wedge body 11 of the movable friction brake lining 10. The direction of action of the linear drive 14 is in the displacement direction of the friction brake lining 10.

A restoring spring element 17 urges the body 11 in a release direction of the disk brake 1.

For actuation of the disk brake 1, the electromagnet 15 of the actuation device 14 is supplied with current and thereby displaces the wedge body 11 along with the movable friction brake lining 10 at the wedge angle α to the brake disk 3, so that the movable friction brake lining 10 is pressed against the brake disk 3. A reaction force displaces the brake caliper 2 transversely to the brake disk 3, so that the fixed friction brake lining 9 is pressed against the other side of the brake disk 3; the brake disk 3 is braked. The brake disk 3, which rotates in the direction of rotation indicated by the arrow 18, exerts a frictional force in the circumferential direction on the friction brake linings 9, 10 pressed against it, which urges the movable friction brake lining 10 in the circumferential direction of the brake disk 3 and in the direction of an increasingly narrower wedge gap between the abutment faces 13 and the brake disk 3. On the principle of the wedge, the abutment faces 13 of the base part 5 of the brake caliper 2 exert a force on the wedge body 11 that has a component that is transverse to the brake disk 3. This force component is a contact pressure, which in addition to the contact pressure exerted by the actuation device 14 presses the friction brake lining 10 against the brake disk 3. The braking force exerted by the actuation device 14 is boosted in this way. The wedge body 11 and the abutment faces 13 of the base part 5 of the brake caliper 2 form a self-energizing device 19 of the friction brake 1 of the invention, which self-energizing device converts a frictional force, exerted by the rotating brake disk 3 on the movable friction brake lining 10 pressed against it, into a contact pressure that presses the friction brake lining 10 against the brake disk 3. The contact pressure of the friction brake lining 10 exerted by the self-energizing device 19 against the brake disk 3 will hereinafter be called the self-energizing force, to distinguish from the contact pressure that the actuation device 14 exerts.

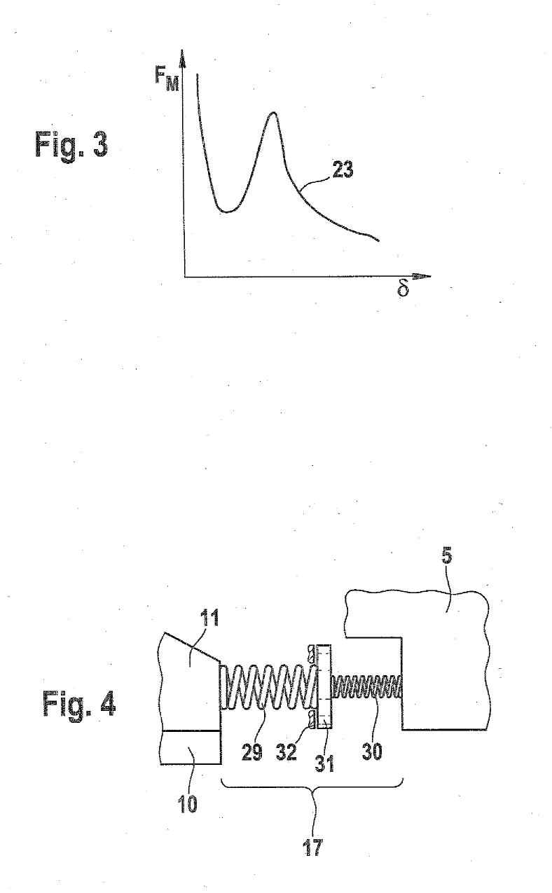

The electromagnet 15, shown in axial section in FIG. 2, of the actuation device 14 has a cylindrical armature 20, which with one end plunges into a pole cup 21. The tappet 16, which passes axially through the pole cup 21, is press-fitted into the armature 20. Supplying electric current to a coil 22 of the electromagnet 15 generates a magnetic field and a magnetic force that pulls the armature 20 into the pole cup 21. A characteristic magnetic force curve 23 is non-proportional; instead, it has for instance the course shown in FIG. 3. In the stroke range or operating range of the electromagnet 15 that is used to displace the friction brake lining 10, the characteristic magnetic force curve 23 of the electromagnet 15 is progressive; that is, a magnetic force increases disproportionately with the travel. The characteristic magnetic force curve 23 indicates the dependence of the magnetic force F_{M} of the electromagnet 15 as a function of the stroke, or the gap marked 6 between the armature 20 and an end wall of the pole cup 21, at constant electrical voltage at the coil 22. The magnetic force F_{M} increases sharply with the approach of the armature 20 to the end wall of the pole cup 21. The course of the characteristic magnetic force curve 23 can be varied by means of the geometric shaping of the armature 20 and pole pot 21. For instance, by means of a conical shape of the armature 20 and/or of the pole cup 21, the size of an annular gap between the armature 20 and the pole cup 21 varies over the stroke of the electromagnet 15. As a result, the magnetic resistance, magnetic field intensity, and magnetic force are changed. By means of the selected progressive characteristic magnetic force curve 23, the magnetic force of the electromagnet 14 increases disproportionately with increasing displacement of the movable friction brake lining 10, or in other words when the actuation force, contact pressure and braking force are high.

The wedge angle α of the disk brake 1 is selected such that at the least coefficient of friction μₘᵢₙ between the movable friction brake lining 10 and the brake disk 3, self-locking of the disk brake 1 occurs; that is, with the disk brake 1 actuated, the friction brake lining 10 remains in its position without force; it neither moves further into the wedge gap between the abutment faces 13 and the brake disk 3 nor out of it.

The restoring spring element 17 is designed such that at the maximum coefficient of friction μₘₐₓ between the movable friction brake lining 10 and the brake disk 3, a force equilibrium is brought about at the friction brake lining 10; that is, the frictional force exerted by the rotating brake disk 3 on the movable friction brake lining 10 pressed against it is as great, at the maximum coefficient of friction μₘₐₓ, as the restoring force of the restoring spring element 17 acting in the release direction of the disk brake 1. As a result, locking of the brake disk 3 is prevented even if the actuation device 14 should fail. For actuating the disk brake 1, the actuation device 14 must merely bring to bear the differential force between the frictional force, exerted by the rotating brake disk 3 on the movable friction brake lining 10 pressed against it, and the restoring force of the restoring spring element 17. The actuation force and actuation energy of the disk brake 1 are reduced as a result. Because of the self-locking design of the disk brake 1 and the compensation with the restoring spring element 17, the actuation force and actuation energy of the disk brake 1 that are necessary to attain a certain braking force are reduced, compared to a self-energizing disk brake 1 that is designed without self-locking and has no restoring spring element 17.

A limitation of the spring force of the restoring spring element 17 and thus of the restoring force exerted on the movable friction brake lining 10 is possible with the serial connection of two springs 29, 30 as shown in FIG. 4. One of the two springs 30 is braced on the base body 5 of the brake caliper 2, only a fraction of which is shown in FIG. 4. The other spring 29 acts on the wedge body 11 that holds the movable friction brake lining 10. Only a fraction of the wedge body 11 and friction brake lining 10 is shown in FIG. 4 as well. Between the two springs 29, 30, there is a disk 31, which is pressed by the spring 30, braced on the base body 5 of the brake caliper 2, against a symbolically represented abutment 32, which is part of the base body 5. The spring 30 is under initial tension. Upon actuation of the disk brake 1, or in other words a displacement of the wedge body 11 with the friction brake lining 10 in a tightening direction, initially only the spring 29 that acts on the wedge body 11 is deformed. Not until the spring force and restoring force of this spring 29 are greater than the initial tension of the spring 30 braced on the base body 5 of the brake caliper 2 is the latter spring 30 elastically deformed. Its spring constant is less than the spring constant of the spring 29 that acts on the wedge body 11, and as a result the characteristic spring curve of the two springs 29, 30 becomes shallower from the moment the disk 31 lifts from the abutment 32; that is, the increase in spring force is reduced with the displacement of the wedge body 11 and is limited by the lower spring constant of the spring 30 that is braced on the base body 5 of the brake caliper 2. The two serially connected springs 29, 30 take the place of the restoring spring element 17 shown in FIG. 1.

The characteristic spring curve of the spring 29 that acts on the wedge body 11 is selected such that at the maximum coefficient of friction μₘₐₓ between the movable friction brake lining 10 and the brake disk 3, not show in FIG. 4, there is an equilibrium between the frictional force exerted by the brake disk 3 on the friction brake lining 10 pressed against it upon braking and the restoring force of the spring 29. The initial tension of the spring 30 braced on the base body 5 of the brake caliper 2 is selected such that when the maximum braking force is attained, at the maximum coefficient of friction μₘₐₓ, the disk 31 lifts from the abutment 32. The increase in the restoring force exerted by the springs 29, 30 and thus in the actuation force to be brought to bear by the actuation device 14 rises only slightly once the initial tension force of the spring 30 is reached; the spring force is limited.

A degressive characteristic spring curve, or even a decreasing spring force, when a maximum spring force is exceeded, can be attained (not shown) for instance with a cup spring or a cup spring assembly as the restoring spring element 17. Cup springs have the property that their spring force decreases when the cup spring, as a result of deformation, approaches the shape of a flat (perforated) disk.

The possible ways described above, for achieving a characteristic spring curve with a pronounced kink by the serial connection of two springs 29, 30, a spring force limitation, a degressive characteristic spring curve, or a spring force that drops again once a maximum spring force is exceeded, reduce both the requisite actuation force and the actuation energy of the disk brake 1 that must be exerted by the actuation device 14 at a high braking force and at a coefficient of friction u that is less than the maximum coefficient of friction μₘₐₓ.

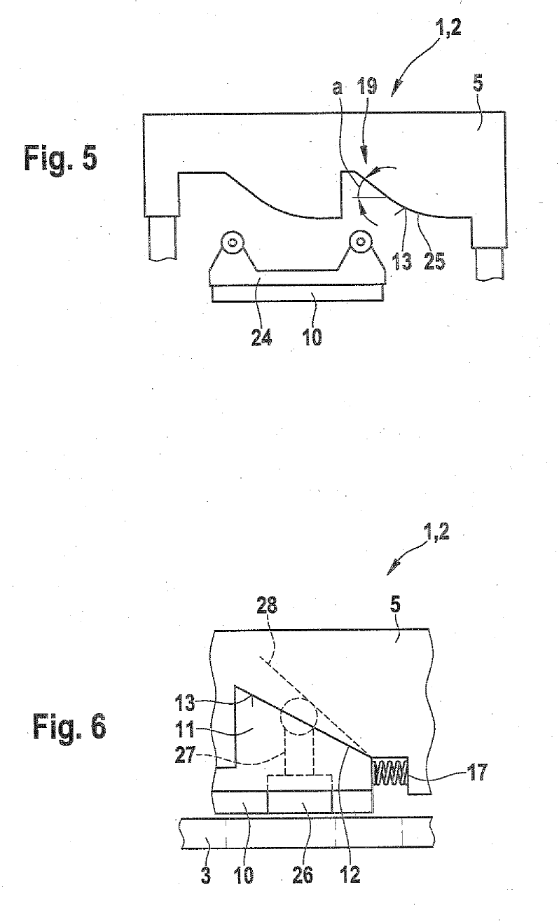

FIG. 5 shows the base body 5 of the brake caliper 2 and the movable friction brake lining 10 of a modified embodiment of the disk brake 1 of the invention. The self-energizing device 19 of the disk brake 1 of FIG. 5 has a ramp mechanism, instead of a wedge mechanism. The abutment faces 13 of the base part of the brake caliper 2 are curves, instead of straight lines; a ramp angle α varies over the course of the abutment faces 13. As a result, the magnitude of the self-energizing varies over the course of the abutment faces 13, which can also be called ramps 25. The movable friction brake lining 10 is attached to a holder 24, by way of which it is braced against the ramps 25. In the disk brake 1 of FIG. 5, there is no restoring spring element 17, but it would be possible for there to be one.

The ramps 25 initially have a straight course; in this region the ramp angle α is selected such that self-locking occurs at the maxim possible coefficient of friction μₘₐₓ between the brake disk 3 and the movable friction brake lining 10. The length of the straight portion of the ramps 25 is selected such that at the maximum coefficient of friction μₘₐₓ, a predetermined maximum braking force of the disk brake 1 is attained. This may for instance be in locking of the brake disk 3 at the maximum coefficient of friction μₘₐₓ. In the further course of the ramps 25, that is, with greater displacement of the movable friction brake lining 10 in the approach direction, the ramp angle α becomes increasingly more-acute; the ramps 25 have a curved course. The magnitude of the self-energizing becomes greater as a result. Ideally, the course of the ramps 25 is selected such that as a function of the coefficient of friction μ, self-locking is attained at maximum braking force. The necessary actuation force and actuation energy are only slight as a result. It must be considered that the movable friction brake lining 10 is always displaced at the most far enough that the maximum braking force of the disk brake 1 is attained. The displacement travel is dependent on the coefficient of friction μ. Moreover, the elastic widening of the brake caliper 2 must be taken into account. At a high coefficient of friction μ, a low contact pressure of the friction brake lining 10 against the brake disk 3 suffices to attain a defined braking force. Thus even the elastic widening of the brake caliper 2 is slight. With a decreasing coefficient of friction μ, the contact pressure necessary to attain the defined braking force, and thus the elastic widening of the brake caliper 2, become greater. The displacement travel of the friction brake lining 10 to attain the defined braking force increases as well. Because of the curved course of the ramps 25, the displacement travel of the friction brake lining 10 required to attain a defined braking force as a function of the coefficient of friction μ is shortened, without exceeding the limit for the self-locking.

With the exception of the differences described above, the disk brakes 1 show in FIGS. 1 and 5 are embodied identically and function in the same way; for explanation of FIG. 5, to avoid repetition, see the explanation of FIG. 1. For identical components, the same reference numerals are used. In particular the actuation device 14 has been omitted from FIG. 5 for the sake of clarity of illustration.

FIG. 6 shows a further embodiment of the disk brake 1 shown in FIG. 1. A father friction brake lining 26 is disposed in the movable friction brake lining 10. It may also be a region of the movable friction brake lining 10 that is not solidly connected (not shown) to the wedge body 11. The further friction brake lining 26 is attached to a tappet 27 that is received in the wedge element 11. The tappet 27 is braced along a curved path 28 that is formed by the bottom of a groove in the abutment face 13. As explained with regard to FIG. 1, the wedge body 11 that carries the movable friction brake lining 10 is braced with its wedge face 12 on the abutment face 13. The intrinsically concealed tappet 27 and the curved path 28 are represented by dashed lines in FIG. 6. A depth of the groove whose bottom forms the curved path 28 decreases over the course of the abutment face 13; that is, the curved path 28 approaches the abutment face 13. The change in spacing between the curved path 28 and the abutment face 13 is shown greatly exaggerated, to make it visible.

If for actuation of the disk brake 1 the movable friction brake lining 10 is displaced, then the tappet 27, which is braced on the curved path 28, causes a relative motion of the further friction brake lining 26 with respect to the movable friction brake lining 10. The further friction brake lining 26, with increasing displacement of the movable friction brake lining 10, is pressed against the brake disk 3 more strongly than the friction brake lining 10. As a result, with the displacement of the movable friction brake lining 10 the total effective coefficient of friction μ between the brake disk 3 and the friction brake linings 10, 26 varies as a function of travel. The coefficient of friction μ is travel-dependent. As a result of this as well, the self-energizing of the brake disk 1 can be varied in a desired way.

With regard to FIG. 6 as well, to avoid repetition, reference is made to the explanation of FIG. 1.

1-12. (canceled)

13. A self-energizing electromechanical friction brakes comprising:
a friction brake lining;
a rotating brake body to be braked;
an actuation device actuating the friction brake to press the friction brake lining against the rotating brake body with a first contact pressure; and
a self-energizing device converting a friction force exerted by the rotating brake body on the friction brake lining during braking actuated by the actuation device into a second contact pressure that presses the friction brake lining against the brake body in addition to the first contact pressure exerted by the actuation device, wherein the actuation device is embodied as a linear drive for pressing the friction brake lining against the brake body.

14. The friction brake according to claim 13, wherein the linear drive has an electromagnet.

15. The friction brake according to claim 14, wherein the electromagnet has a non-proportional characteristic magnetic force curve.

16. The friction brake according to claim 15, wherein the electromagnet has a progressive characteristic magnetic force curve.

17. The friction brake according to claim 13, wherein the self-energizing device is embodied as a self-locking device.

18. The friction brake according to claim 13, wherein the friction brake has a restoring spring element, which urges the friction brake in a brake release direction.

19. The friction brake according to claim 18, wherein the self-energizing device is embodied as a self-locking device, and the restoring spring element, at the maximum coefficient of friction μₘₐₓ between the friction brake lining and the brake body, generates a force equilibrium between the contact pressure, exerted by the self-energizing device, and a restoring force of the restoring spring element.

20. The friction brake according to claim 13, wherein the restoring spring element has a non-proportional characteristic spring curve.

21. The friction brake according to claim 20, wherein the restoring spring element has a spring force limitation.

22. The friction brake according to claim 20, wherein the restoring spring element has a digressive characteristic spring curve.

23. The friction brake according to claim 13, wherein a self-energizing effect of the self-energizing device increases with increasing tightening of the friction brake.

24. The friction brake according to claim 13, wherein the friction brake has a coefficient of friction μ that is dependent on a displacement of the friction brake lining in a tightening direction.
